(19) United States
(12) Patent Application Publication
(10) Pub. No.: US 2014/0283121 A1
(43) Pub. Date: Sep. 18, 2014

(54) Computer Systems and Methods for Capturing Electronic Service Requests and Responses

(71) Applicant: MASSACHUSETTS MUTUAL LIFE INSURANCE GROUP, Springfield, MA (US)

(72) Inventors: Mikhail Livshits, Canton, CT (US); Richard Byron Saunders, V, South Hadley, MA (US)

(21) Appl. No.: 13/826,274

(22) Filed: Mar. 14, 2013

(51) Int. Cl. G06F 21/62

(52) U.S. Cl. CPC G06F 21/6245
USPC 726/28

(57) ABSTRACT

A system and method for capturing electronic service requests and responses are disclosed. According to one aspect, the system is configured to monitor and/or capture electronic service requests and responses. Service providers and/or consumers may provide information that is utilized to determine an accessibility level that is to be associated with the electronic service requests and responses. The accessibility level may then be stored and/or associated with the electronic service request and/or response data for subsequent use by a user who meets the defined access criteria in order to derive valuable information from the electronic service request and response data that is stored. In some embodiments, a tiered architecture of access may be utilized to allow different users access to different types of service request and response data.

### FIELD OF THE TECHNOLOGY

Embodiments of the present subject matter relate to an automated computer system and method for capturing and providing conditional access to electronic service requests and responses.

### BACKGROUND

Service providers utilize electronic service requests that are submitted by consumers requesting service in different ways. For example, service providers may provide web-based services to consumers via the internet and/or may process other service requests that are submitted by consumers electronically (e.g., through the internet). These services are particularly useful to provide consumers information regarding their financial transactions and accounts.

### SUMMARY

According to one aspect, an apparatus for accessing to electronic service data is disclosed. The apparatus includes a memory comprising electronic service data and conditional access data associated with the electronic service data, wherein the electronic service data comprises data regarding one or more electronic service requests and/or electronic service responses, and a processor operatively coupled to the memory. The processor is configured to receive a request for access to the electronic service data, determine an access level associated with the request for access, compare the determined access level with the conditional access data stored in the memory, and provide access to the electronic service data based at least in part on the comparison.

According to another aspect, a computer-implemented method for accessing electronic service data that is stored in a memory is disclosed. The memory includes conditional access data associated with the electronic service data. The computer-implemented method includes receiving, via a computer interface, a request for access to the electronic service data that is stored in the memory. The electronic service data includes data regarding one or more electronic service requests and/or electronic service responses. The computer-implemented method also includes determining, via one or more computer processors, an access level associated with the request for access, comparing, via the one or more computer processor, the determined access level with the conditional access data stored in the memory, and providing access, via the computer interface, to the service data based at least in part on the comparison.

According to another aspect, a non-transitory computer readable medium having stored thereon a computer program product that is capable of being executed by computer processing circuitry is disclosed. The computer program product includes instructions for causing the processing circuitry to receive a request for access to electronic service data stored in memory, wherein the memory includes conditional access data associated with the electronic service data, and wherein the electronic service data includes data regarding one or more electronic service requests and/or electronic service responses, determine an access level associated with the request for access, compare the determined access level with the conditional access data stored in the memory, and provide access to the electronic service data based at least in part on the comparison.

### BRIEF DESCRIPTION OF THE DRAWINGS

Aspects and embodiments of the present disclosure will be described with reference to the following figures. It should be appreciated that the figures are not necessarily drawn to scale. Items appearing in multiple figures are indicated by the same reference number in all the figures in which they appear.

FIG. 1 is a flowchart of a computer-implemented method of capturing electronic service requests and responses according to some embodiments of the present disclosure.

FIG. 2 is a flowchart of an example of a computer-implemented method of providing access to captured electronic service requests and responses according to some embodiments of the present disclosure.

FIG. 3 illustrates a functional block diagram of a computer system for capturing and providing access to electronic service requests and responses according to some embodiments of the present disclosure.

FIG. 4 illustrates a user interface for a computer system for processing electronic service requests and responses according to some embodiments of the present disclosure.

FIG. 5 illustrates an example of a database of electronic service requests and responses according to some embodiments of the present disclosure.

### DETAILED DESCRIPTION OF EMBODIMENTS

The demand for web-based services and electronic transactions has resulted in an increase in the types of services that are provided to consumers through electronic service requests. For example, a consumer who previously had to complete a form to change personal information for a financial account can now submit a web-based or electronic service request to have the account updated. These electronic service requests may then processed by a service provider's designated department for handling the service and/or a third party that has been contracted to handle the type of requested service. Following the completion of the service request, an electronic service response is generated and communicated to the consumer in order to update data that is available to the consumer and/or reflect that service has been completed.

According to some embodiments of the present disclosure, a system and method are provided for monitoring and/or capturing the electronic service requests and responses. Service providers and/or consumers may provide information that is utilized to determine an accessibility level that is to be associated with the electronic service requests and responses. The accessibility level may then be stored with the electronic service request and/or response data for subsequent use by a user who meets the defined access criteria in order to derive valuable information from the stored electronic service request and response. In some embodiments, a tiered architecture of access may be utilized to allow different users access to different types of service request data and/or response data.

FIG. 1 is a flowchart of a computer-implemented method 100 of capturing service requests and responses according to some embodiments of the present disclosure. As shown in FIG. 1, the computer-implemented method 100 includes receiving a service request at block 102. The service request is an electronically submitted request and may include a request that is transmitted through the internet. The service request may be, for example, a request for processing of a financial transaction (e.g., an electronic fund transfer, investment fund purchase or sale, account asset allocation, request for information regarding a loan, or the like). In some embodiments, the service request may be a request to manage or change personal information associated with a consumer's account (e.g., name, address, contact information, or the like) through a web-based interface. In some embodiments, the electronic service request includes a request to issue a policy (e.g., an insurance policy), request a loan, and/or request a reservation or information regarding a reservation (e.g., hotel accommodations, car rental, or the like). In some embodiments, a service request file (e.g., an XML file or the like) may be generated by an application that is executed by a consumer's device and/or a service provider's processor. The generated service request file may be based on data that is retrieved and provided by a service consumer. For example, a service consumer may populate fields of a request form in order to provide data that is pertinent to the request, such as the parameters of the information that is be changed, and an application that is stored in a consumer device memory and/or a service provider's memory can be executed by the consumer's device and/or the service provider's processor. The application may generate an electronic request file including data that is provided. in a format that can be understood by the service provider's processor. In some embodiments, a service mediator (e.g., a software application) may be utilized to provide translation, authentication, and other mediation services for both the service provider and service consumer. The service mediator application may be stored and executed on a consumer's device and/or a service provider's device. The service mediator may be utilized in order to translate a service request into a format that can be understood by a service provider's processor. Following receipt of the service request, a service provider may process the requested service based on the data contained in the service request. For example, a service provider may update a consumer's personal information based on the data provided in the service request.

The computer-implemented method 100 also includes generating and sending an electronic service response as shown in block 104. In some embodiments, the service response is generated directly by a service provider's processor, for example, by an application that is executed by the service provider's processor. In some embodiments, as discussed above, the service provider may provide data to a mediator or third party application in order to communicate the service response. In some embodiments, a service response file (e.g., an XML file or the like) may be generated by an application based on information that is provided by a service provider. For example, a service provider's processor may populate fields of a response form in order to provide data that is pertinent to the consumer's request, such as the parameters of the information that has been changed, and an application may generate an electronic response file including data that is provided in a format that can be displayed or communicated to a service consumer.

The computer-implemented method 100 also includes storing the service request and response in memory as shown in block 106. In some embodiments, an electronic file (e.g., a service request XML file) which contains all data regarding the service request is stored along with an electronic file (e.g., a service response XML file) in a database. In some embodiments, data regarding the service request and the service response may be extracted from the service request and/or response and stored in a database. For example, particular fields of a service request and/or response file, such as the nature of the service provided, the time the service request was submitted, the time the service response was sent, and/or the results of the service provided may be extracted and stored in a database. In some embodiments, an application, such as a mediator, may be utilized in order to process and/or translate a service request and/or service response to extract particular data for storage in the memory.

The computer-implemented method 100 also includes generating and storing accessibility data for the stored service request and/or response data as shown in block 108. In some embodiments, service request and response data that is stored in memory is individually associated with a particular access level that is necessary to view and/or retrieve the data. For example, service providers may designate access levels to the service request and response data based on different internal departments. Employees in departments which are responsible for the particular services may be granted access only to those service requests and responses which were handled by their department. Higher levels of access may be provided to system administrators and/or other designated personnel. In some embodiments, particular service request and response information may be provided to third parties. For example, service requests and responses may be captured for services that are performed by a third party, and the third party may subsequently be granted access to the captured data, in some embodiments, access may be granted to individual personnel and/or organizational entities that have processed and/or are responsible for the service request. For example, for electronic service requests related to loan applications, the system may grant access to all loan application processing department personnel, and to underwriters who are involved in issuing the particular loan. In some embodiments, the system may grant access to particular personnel and/or organizational entities regardless of whether they are responsible for and/or have processed the service requests. For example, in some embodiments, access may be granted to all underwriters within an organization to all electronic service requests that relate to loan applications. In some embodiments, service request and response data stored in memory may be encrypted in order to decrease the likelihood of unauthorized access to the data.

FIG. 2 is a flowchart of an example of a computer-implemented method 200 of providing access to captured electronic service requests and responses according to some embodiments of the present disclosure. As shown in FIG. 2, the method 200 includes receiving a request for access to service request data and/or service response data as shown in block 202. For example, as discussed above, a request may be made by a service provider to access captured service request and response data in order to analyze the data. The analysis of the data can include, for example, determining the frequency and type of requests that are made, determining particular problems that are reported in the process of handling a previous service request, determining demographic and/or other characteristics associated with service consumers, and/or the like. In some embodiments, the data may be analyzed in order to determine additional performance metrics of the services performed. These performance metrics may include: how often a particular consumer utilizes the requested service, the average and/or maximum time for processing an electronic service request, and/or determining the types of requests that are associated with particular types of accounts (e.g., high net-worth accounts).

The computer-implemented method 200 also includes receiving user authentication information as shown in block 204. For example, a request for access may include username and password information that is assigned to a requesting party, and/or other information that accompanies a user's request for access (e.g. an identifier of a user's device). An access database may be maintained which includes accepted username/password combinations along with an associated access level which corresponds to the user. As shown in block 206, the computer-implemented method 200 also includes determining a user access level. The user access level may be determined by retrieving the associated access level stored in the access database. At decision block 208, the computer-implemented method 200 determines whether the user has an associated access level. If the user has no access (e.g., the username/password combination provided by the user does not exist in the access database), the request for access to the service request and response information is denied as shown in block 212. If the user has access (e.g., the username/password combination provided by the user has an associated access level in the access database), the service request and response data is sent to the user based on the retrieved access level as shown in block 210, in some embodiments, tiers of access to the service request and response data may be dictated by different access levels. For example, users having the highest access level are sent and/or provided access to all service request and response data that is stored in the system, while users with lower access levels are sent and/or provided access to only some of the service request and response data based on their access level. In some embodiments, all data included in a particular service request and/or a service response may be associated with the same access level. In some embodiments, data contained in each of the service requests and service responses may be associated with different access levels. For example, a user may be granted access to service request and response data without being granted access to a consumer's personal identifying information (e.g., name, address, and/or account number) that is included in the service request and/or service response. As a result, a multi-dimensional or tiered view of service request and response traffic may be generated and monitored by different service providers and/or different entities associated with a service provider.

FIG. 3 illustrates a functional block diagram of a computer system 300 for capturing and providing access to electronic service requests and responses according to some embodiments of the present disclosure. The computer system 300 may be utilized, for example, to perform the computer-implemented methods 100 and 200 discussed above with reference to FIGS. 1 and 2. The computer system 300 includes a service request and/or response processor 302 that is in communication with a user interface 304, a service request and/or response database 306, a service provider processor 314, and an access database 316. As shown in FIG. 3, the service request and/or response database 306 may be stored in a computer-readable memory 305, while the access database 316 may be stored in a computer-readable memory 315. While shown separately, the computer-readable memories 305 and 315 may be a single computer-readable memory. In some embodiments, the computer-readable memories 305 and 315 are part of a service provider's computer network and/or system.

The communication links between each of the components illustrated in FIG. 3 may be wired communication links and/or wireless communication links (e.g., via a local area network and/or the internet). While shown separately, at least one of (e.g., all of) the service request and/or response processor 302, the user interface 304, the service request and/or response database 306, the service provider processor 314, and the access database 316 may be integrated in a single device. The memory (e.g., computer-readable memory 305 and 315) for storing one or more of the databases 306 and 316, along with processing circuitry implementing the service request and/or response processor 302 (e.g., by executing a computer program) may be provided in the same device or in different devices.

In some embodiments, the service provider processor 314, the service request and/or response database 306, and the service request and/or response processor 302, and the access database 316 may be under the control of and reside with a service provider and/or an agent of the service provider. In some embodiments, the user interface 304 corresponds to a consumer's terminal that is utilized to send service requests and responses. In some embodiments, the user interface 304 corresponds to a terminal that is under the control of the service provider, an agent of the service provider, and/or a third party that is requesting access to the service request and/or response data.

The service request and/or response processor 302 may include a plurality of modules for implementing multiple functions. The service request and/or response processor 302 may include a general purpose processor or processing circuitry that is configured to receive and execute instructions for performing the functions which will be described in greater detail below with reference to each of the modules. Further, each of the modules may be implemented in hardware and/or software. When implemented in software, each of the modules may be implemented by the same or different general purpose processors or processing circuits that are configured to execute the instructions contained therein.

In some embodiments, electronic service requests and response may be provided in a self-describable format. For example, an electronic service request and/or an electronic service response may include a field identifying the type of service. In some embodiments, electronic service requests and responses may be associated in the database by the type of service that is identified. In some embodiments, the electronic service requests and responses may be associated by the service provider who is responsible for processing the service request and who provided the service response. In some embodiments, service requests and responses may be associated by the consumer requesting the service and/or the type of consumer requesting the service. For example, a consumer identifier may be included in the electronic service request and/or response which identifies the particular consumer (e.g., a user ID) and/or the type of consumer (e.g., by including information indicating whether the consumer is an individual, small business, or other entity). Access to the electronic service requests and responses may be based on one or more parameters which associate the service requests with the service responses (e.g., service provider, consumer identifier, or other parameter).

In some embodiments, search and/or filtering tools may be utilized to retrieve electronic service requests and/or responses. For example, an application protocol interface (API) may be provided to a user that is requesting access to electronic service request and/or response data. The user, through the API, may define particular search criteria which are utilized to retrieve particular service request and/or response data. The retrieved data may be limited to the service requests and/or responses to which the user has access. For example, entire service requests and/or response may be provided to the user based on their access level or subsets of information contained within the service requests and/or responses may be provided to the user based on their access level).

As shown in FIG. 3, the service request and/or response processor 302 includes an interface control module 308, a service request and/or response capture module 310, and an accessibility module 312. The interface control module 308 is configured to interact with the user interface 304 and the service provider processor 314 in order to send and receive communication from the service request and/or response processor 302. The service request and/or response capture module 310 is configured to capture data included in a service request and/or response, and/or capture an entire service request and/or service file (e.g., an XML file) in order to store data regarding the captured service requests and/or responses in the service request and/or response database 306. The accessibility module 312 is configured to generate access level data that is stored in association with the captured service requests and/or responses, in some embodiments, the accessibility module 312 may include a multi-tiered application that includes functions for retrieval of service request and/or response data, retrieval and processing of messages for accessing electronic service request and/or response data, application of access rules and conditional access levels, and communication of responses to requests for access to service request and/or response data.

The service requests may be communicated through the service request and/or response processor 302 by a service consumer utilizing the user interface 304 or through a mediator (e.g. a software application for translating the service request) as discussed above, while the service responses may be communicated by the service provider processor 314 or a mediator (e.g., a software application for translating the service response) following completion of the requested service.

In some embodiments, the user interface 304 may include a touch-screen display and/or may be a display that is operatively coupled to an input device such as a keyboard or a mouse. The user interface 304 may be utilized by a consumer for requesting services and/or may be utilized by a service provider who wishes to request access to captured service requests and response. When a request for access is made through the user interface 304, the accessibility module 312 is configured to query the access database 316 in order to determine the user's access level. For example, the accessibility module 312 compares a received user name/password combination and/or other identifier with one or more entries in the access database 316 in order to determine whether the user has access and the level of access that is to be granted to the user. Following this determination, the user's access level is utilized by the accessibility module 312 to retrieve the corresponding service requests and/or response, or portions of data thereof, based on the user's access level. The service requests and/or response data that the user has access to may be communicated directly to the user through the interface control module 308 and the user interface 304. For example, the interface control module 308 may be configured to format the data retrieved from the service request and/or response database 306 in order to provide the data in a form that is compatible with or understood by the user interface 304. In some embodiments, while not shown, the service request and/or response processor 302 may include or be in communication with an analysis processor that is configured to generate an aggregated analysis of the data that is retrieved from the service request and/or response database 306 for the user. The parameters defining the analysis may be communicated by the user to the analysis module through the user interface 304. The aggregated analysis may then be communicated to the requesting user. In some embodiments, the service request and/or response data may be communicated to a user in a particular format that is requested by the user (e.g., a spreadsheet, text file, or the like). Upon receiving the service request and/or response data, users may utilize data-mining software in order to derive useful information for the retrieved data. In some embodiments, users may perform initial processing in order to filter the data and may send the results to third party consultants or contractors. For example, a user may employ a third party to conduct advertising campaigns based on the analysis of the service request and/or response data. Based on information that is derived through the analysis, particular prospects may be identified and aligned with the user's service offerings for more effective advertising.

FIG. 4 illustrates a user interface for a computer system for processing electronic service requests and responses. As shown in FIG. 4, the user interface may be utilized to receive service request information as shown in display area 402. For example, a service request may include information such as an account holder name, account number, account balance, a current investment allocation of the account, and/or a desired investment allocation for the account. The user may then submit the request to change the investment allocation through the user interface. Following completion of the service request by the service provider, a service response may be displayed by the user interface as shown in display area 404. In some embodiments, the service request data and the service response data that is stored in the service request and/or response database 306 may include additional information that is not provided to the user through the user interface.

FIG. 5 illustrates an example of a database 506 of electronic service requests and responses. The database 506 may correspond to a portion of the service request and/or response database 306 discussed above with reference to FIG. 3. As shown in FIG. 5, the database 506 includes a copy of each service request and service response that has been captured, along with an associated accessibility level. As discussed above, the associated accessibility levels may require a particular user access level in order to allow access to the corresponding service request and/or service response (or underlying types of data contained therein). Each captured service request and response combination entry may also include an assigned service number, as well as other identifying information such as the date the service request was received and the date that the service response was sent.

Each of the various illustrative logical blocks, modules, processors, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium or memory. Computer-readable media include both non-transitory computer storage media and communication media including any medium that facilitates transfer of a computer program. A storage medium may be any available media that can be accessed by a computer. By way of example, and not limitation, such computer-readable media can include non-transitory computer-readable media including RAM, ROM, EEPROM, CD-ROM or other optical disk storage, magnetic disk storage or other magnetic storage devices, or any other medium that can be used to carry or store desired program code in the form of instructions or data structures and that can be accessed by a computer. A computer-readable medium can include a communication signal path. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

The system may include various modules as discussed above. As can be appreciated by one of ordinary skill in the art, each of the modules may include one or more of a variety of sub routines, procedures, definitional statements and macros. Each of the modules may be separately compiled and linked into a single executable program. Therefore, the description of each of the modules is used for convenience to describe the functionality of the disclosed embodiments. Thus, the processes that are undergone by each of the modules may be redistributed to one of the other modules, combined together in a single module, or made available in, for example, a shareable dynamic link library.

The system may be used in connection with various operating systems such as Linux®, UNIX® or Microsoft Windows®. The system may be written in any conventional programming language such as C, C++, BASIC, Pascal, or Java, and ran under a conventional operating system. The system may also be written using interpreted languages such as Visual Basic (VB.NET), Perl, Python or Ruby.

It will be appreciated by those skilled in the art that various modifications and changes may be made without departing from the scope of the described technology. Such modifications and changes are intended to fail within the scope of the embodiments that are described. It will also be appreciated by those of skill in the art that features included in one embodiment are interchangeable with other embodiments; and that one or more features from a depicted embodiment can be included with other depicted embodiments in any combination. For example, any of the various components described herein and/or depicted in the figures may be combined, interchanged, or excluded from other embodiments.

What is claimed is:

1. An apparatus for accessing to electronic service data, the apparatus comprising:
a memory comprising electronic service data and conditional access data associated with the electronic service data, wherein the electronic service data comprises data regarding one or more electronic service requests and/or electronic service responses; and
a processor operatively coupled to the memory and configured to:
receive a request for access to the electronic service data;
determine an access level associated with the request for access;
compare the determined access level with the conditional access data stored in the memory; and
provide access to the electronic service data based at least in part on the comparison.

2. The apparatus of claim 1, wherein the electronic service data includes data corresponding to a plurality of consumers.

3. The apparatus of claim 1, wherein the processor is further configured to:
receive electronic service request data;
receive electronic service response data;
identify the electronic service response data that is associated with the electronic service request data;
determine an access level for the electronic service request data and the electronic service response data, the access level including data indicative of users that are permitted access to the electronic service request data and the electronic service response data; and
save the identified electronic service request data, the electronic service response data, and the access level in the memory.

4. The apparatus of claim 1, further comprising a user interface, wherein the request for access is received through the user interface.

5. The apparatus of claim 1, wherein the request for access includes user identification information, and wherein the processor is configured to determine the access level based on the user identification information.

6. The apparatus of claim 5, wherein the user identification information comprises a user name and password.

7. The apparatus of claim 1, wherein the electronic service request corresponds to a service request received via the internet.

8. The apparatus of claim 1, wherein the electronic service request comprises a request to change financial account information.

9. A computer-implemented method for accessing electronic service data that is stored in a memory, the memory including conditional access data associated with the electronic service data, the computer-implemented method comprising:
receiving, via a computer interface, a request for access to the electronic service data that is stored in the memory, the electronic service data including data regarding one or more electronic service requests and/or electronic service responses;
determining, via one or more computer processors, an access level associated with the request for access;
comparing, via the one or more computer processor, the determined access level with the conditional access data stored in the memory; and
providing access, via the computer interface, to the service data based at least in part on the comparison.

10. The method of claim 9, wherein the electronic service data includes data corresponding to a plurality of consumers.

11. The method of claim 9, further comprising:
receiving electronic service request data;
receiving electronic service response data;
identifying the electronic service response data that is associated with the electronic service request data;
determining an access level for the electronic service request data and the electronic service response data, the access level including data indicative of users that are permitted access to the electronic service request data and the electronic service response data; and
saving the identified electronic service request data, the electronic service response data, and the access level in the memory.

12. The method of claim 9, wherein the request for access includes user identification information, and wherein the access level is determined based on the user identification information.

13. The method of claim 12, wherein the user identification information comprises a user name and password.

14. The method of claim 9, wherein the electronic service request corresponds to a service request received via the internet.

15. The method of claim 9, wherein the electronic service request comprises a request to change financial account information.

16. A non-transitory computer readable medium having stored thereon a computer program product that is capable of being executed by computer processing circuitry, the computer program product including instructions for causing the processing circuitry to:
receive a request for access to electronic service data stored in memory, wherein the memory includes conditional access data associated with the electronic service data, and wherein the electronic service data includes data regarding one or more electronic service requests and/or electronic service responses;
determine an access level associated with the request for access;
compare the determined access level with the conditional access data stored in the memory; and
provide access to the electronic service data based at least in part on the comparison.

17. The non-transitory computer readable medium of claim 16, wherein the electronic service data includes data corresponding to a plurality of consumers.

18. The non-transitory computer readable medium of claim 16, wherein the computer program product includes instructions causing the processing circuitry to:
receive electronic service request data;
receive electronic service response data;
identify the electronic service response data that is associated with the electronic service request data;
determine an access level for the electronic service request data and the electronic service response data, the access level including data indicative of users that are permitted access to the electronic service request data and the electronic service response data; and
save the identified electronic service request data, the electronic service response data, and the access level in the memory.

19. The non-transitory computer readable medium of claim 16, wherein the request for access includes user identification information, and wherein the access level is determined based on the user identification information.

20. The non-transitory computer readable medium of claim 19, wherein the user identification information comprises a user name and password.

21. The non-transitory computer readable medium of claim 16, wherein the electronic service request corresponds to a service request received via the internet.

22. The non-transitory computer readable medium of claim 16, wherein the electronic service request comprises a request to change financial account information.
